(19) United States
(12) Patent Application Publication
(10) Pub. No.: US 2020/0133203 A1
(43) Pub. Date: Apr. 30, 2020

(54) TIME CORRECTION DEVICE AND TIME CORRECTION METHOD

(71) Applicant: SEIKO EPSON CORPORATION, Tokyo (JP)

(72) Inventor: Tetsuro ANDO, Shiojiri-shi (JP)

(73) Assignee: SEIKO EPSON CORPORATION, Tokyo (JP)

(21) Appl. No.: 16/663,450

(22) Filed: Oct. 25, 2019

(30) Foreign Application Priority Data
Oct. 26, 2018 (JP) 2018-201568

(51) Int. Cl. G04B 27/02

(52) U.S. Cl. CPC G04B 27/02

(57) ABSTRACT

A time correction device includes a mounting stand on which a watch is mounted, a detector configured to detect a position of a hand of the watch mounted on the mounting stand, an operation mechanism configured to operate a crown of the watch mounted on the mounting stand, a timekeeping circuit configured to keep an internal time, and a control circuit configured to acquire an indicated time indicated by the hand from the position of the hand and control the operation mechanism to rotate the crown in accordance with a difference between the internal time and the indicated time and thus correct the indicated time to the internal time.

The present application is based on, and claims priority from JP Application Serial Number 2018-201568, filed Oct. 26, 2018, the disclosure of which is hereby incorporated by reference herein in its entirety.

### BACKGROUND

### 1. Technical Field

The present disclosure relates to a time correction device and a time correction method for a watch.

### 2. Related Art

JP-A-2016-90507 discloses a technique for correcting the time of a mechanical watch. According to this technique, the displayed time is corrected by acquiring the displayed time of the mechanical watch by an image taken by a smart phone or a time entered manually, opening a case back, and driving a toothed gear accordingly.

Nevertheless, in the technique described in JP-A-2016-90507, the time of the watch is corrected by driving the toothed gear exposed with the case back opened, resulting in a cumbersome method of use.

### SUMMARY

A time correction device according to an aspect of the present disclosure includes a mounting stand on which a watch is mounted, a detector configured to detect a position of a hand of the watch mounted on the mounting stand, an operation mechanism configured to operate a crown of the watch mounted on the mounting stand, a timekeeping circuit configured to keep an internal time, and a control circuit configured to acquire an indicated time indicated by the hand from the position of the hand and control the operation mechanism to rotate the crown in accordance with a difference between the internal time and the indicated time and thus correct the indicated time to the internal time.

In the aspect described above, the control circuit may be configured to control the operation mechanism prior to rotating the crown to pull out the crown at a time correction position for interlocking the hand with rotation of the crown.

In the aspect described above, the control circuit may be configured to control the operation mechanism to increase, over time, a force for pulling out the crown.

In the aspect described above, the control circuit may be configured to control the operation mechanism to push in the crown at a normal position for driving the hand synchronously with time when the indicated time matches the internal time.

In the aspect described above, the control circuit may be configured to control the operation mechanism to operate the crown based on a pattern specific to a caliber of the watch.

In the aspect described above, the detector may be configured to take an image including a scale of a dial of the watch indicated by the hand to detect a position of the hand.

In the aspect described above, the detector may be a two-dimensional image sensor that uses a solid state imaging element.

A time correction method according to an aspect of the present disclosure includes detecting a position of a hand of a watch mounted on a mounting stand by a detector, keeping an internal time by a timekeeping circuit, acquiring an indicated time indicated by the hand from the position of the hand by a control circuit, and controlling, by the control circuit, an operation mechanism configured to operate a crown of the watch mounted on the mounting stand to rotate the crown in accordance with a difference between the internal time and the indicated time and thus correct the indicated time to the internal time.

### BRIEF DESCRIPTION OF THE DRAWINGS

FIG. 1 is a top view for explaining a time correction device according to a first exemplary embodiment.

FIG. 2 is a front view for explaining an example of a watch.

FIG. 3 is a block diagram for explaining an example of a general configuration of the time correction device according to the first exemplary embodiment.

FIG. 4 is a front view for explaining an example of an operation unit, viewed from an axial direction of a crown.

FIG. 5 is a front view for explaining another example of the operation unit, viewed from the axial direction of the crown.

FIG. 6 is a top view for explaining an operation mechanism that moves in a mounting stand.

FIG. 7 is a flowchart for explaining an example of a time correction method by the time correction device according to the first exemplary embodiment.

FIG. 8 is a top view for explaining an example of the time correction device according to a first modified example of the first exemplary embodiment.

FIG. 9 is a side view for explaining an example of the time correction device according to a second modified example of the first exemplary embodiment.

FIG. 10 is a flowchart for explaining an example of a watch for which time is corrected by the time correction device according to a second exemplary embodiment.

FIG. 11 is a flowchart for explaining an example of a time correction method by the time correction device according to the second exemplary embodiment.

FIG. 12 is a flowchart continuing from the flowchart of FIG. 11.

FIG. 13 is a table for explaining caliber information used in the time correction device according to a third exemplary embodiment.

### DESCRIPTION OF EXEMPLARY EMBODIMENTS

A time correction device and a time correction method according to exemplary embodiments of the present disclosure will be described below with reference to the accompanying drawings. Each exemplary embodiment is illustrated as an example of a device or a method which represents the technical concept of the present disclosure. The technical concept of the present disclosure is not limited to the materials, shapes, structures, arrangements, and the like of the components described below. In the following drawings, the same or similar components are denoted by the same or similar reference signs, and duplicate descriptions thereof are omitted. The drawings are schematic, and the dimensions, relative ratios of dimensions, arrangements, structures, and the like may differ from actual ones.

Note that the definition of a direction, such as up, down, left, or right, in the following is merely a definition for convenience of description, and does not limit the technical concept of the present disclosure. For example, up and down are understood as left and right when an observed object is rotated 90° about a line-of-sight direction, and up, down, left, and right are understood as inverted when an observed object is rotated 180° about the line-of-sight direction. The technical concept of the present disclosure can vary within the technical scope set forth in the claims.

### First Exemplary Embodiment

As illustrated in FIG. 1, a time correction device 1 according to a first exemplary embodiment includes a mounting stand 11 on which a watch 2 is mounted, a detector 12 configured to detect a position of a hand 21 of the watch 2 mounted on the mounting stand 11, an operation mechanism 13 configured to operate a crown 22 of the watch 2 mounted on the mounting stand 11, a timekeeping circuit 14 configured to keep an internal time, and a control circuit 30. The control circuit 30 is configured to acquire an indicated time indicated by the hand 21 from a position of the hand 21 detected by the detector 12, and control the operation mechanism 13 to rotate the crown 22 in accordance with a difference between the internal time and the indicated time, and thus correct the indicated time to the internal time.

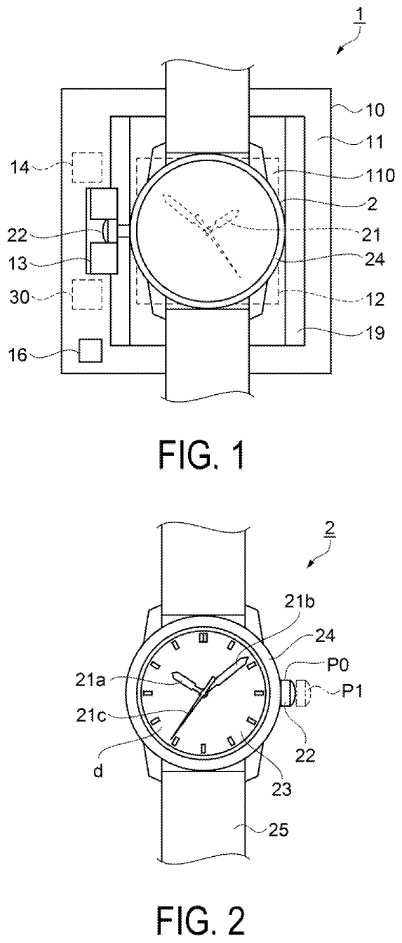

As illustrated in FIG. 2, the watch 2 is a mechanical watch including, for example, an hour hand 21a, a minute hand 21b, and a second hand 21c. The watch 2 is a wrist watch worn on an arm of a user by a band 25, for example. In this case, the hand 21 is defined as being at least one of the hour hand 21a, the minute hand 21b, and the second hand 21c. The hand 21 need only be a hand allowing acquisition of at least a portion of the indicated time by the control circuit 30 from a position detected by the detector 12, and driven in conjunction with the rotation of the crown 22. That is, the hand 21 can be the hour hand and the minute hand of a watch in which the hour and the minute are adjusted by rotation of the crown, for example. The hand 21 can be the second hand of a watch in which the second is adjustable by rotation of the crown, for example.

The crown 22 protrudes out and is exposed from a case 24 housing the components of the watch 2. The crown 22 moves in an axial direction, that is, in a left and right direction in FIG. 2. For example, as illustrated in FIG. 2, the crown 22 moves incrementally to a position P0 at stage 0 and a position P1 at stage 1 of the watch 2. In the watch 2, the position P0 is a normal position, and the position P1 is a time correction position. For example, when the crown 22 is in the normal position, the hand 21 is driven in synchronization with the time kept by the watch 2. When the crown 22 is in the time correction position, the hand 21 is interlocked with the rotation of the crown 22. Specifically, when the crown 22 is in the position P1, the second hand 21c is stopped, and the hour hand 21a and minute hand 21b are driven clockwise in conjunction with the rotation of the crown 22. The watch 2 may be a watch of another type, such as an analog quartz watch provided that the watch includes the hand 21 that indicates the time and the crown 22 that drives the hand 21.

For example, as illustrated in FIG. 1, the time correction device 1 includes a housing 10 that houses components including the detector 12, the timekeeping circuit 14, and the control circuit 30. The mounting stand 11 may form an upper portion of the housing 10. The mounting stand 11 includes a detection window 110 for transmitting light, for example. The watch 2 is mounted on an upper surface of the mounting stand 11 with a display face d (refer to FIG. 2) that displays the hand 21 and a dial 23. The time correction device 1 further includes a regulating portion 19 that regulates displacement of the case 24 caused by the operation mechanism 13 operating the crown 22. The regulating portion 19 may have undulations that come into contact with the watch 2 and guide the case 24 to a predetermined position when the user mounts the watch 2 onto the mounting stand 11, and may chuck the watch 2 from two or more directions to fix the case 24 into the predetermined position. The regulating portion 19 may regulate displacement of the case 24 by being wound around the band 25. In other words, the regulating portion 19 may include a member around which the band 25 is wound, like a human arm.

The detector 12 detects the position of the hand 21 on the dial 23 by taking an image that includes a direction indicated by the hand 21 or a mark on the dial 23 indicated by the hand 21. The detector 12 is a two-dimensional image sensor that uses, for example, a solid state imaging element. The time correction device 1 may include a light source such as a light emitting diode (LED) that irradiates the dial 23 with light such as infrared or visible light to facilitate position detection of the hand 21 in the dark or the like. The detector 12 is disposed below the mounting stand 11, making it possible to suppress an increase in dimension in a height direction of the time correction device 1.

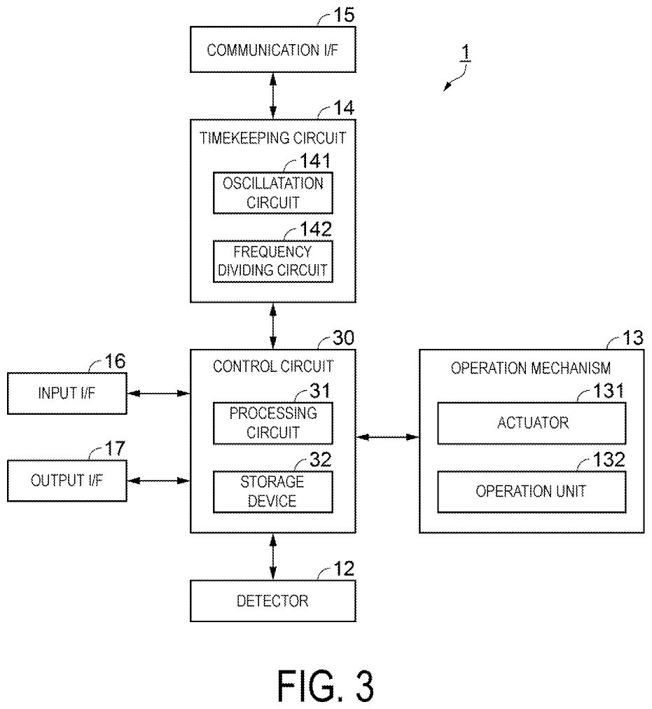

As illustrated in FIG. 3, the timekeeping circuit 14 may include, for example, an oscillation circuit 141 that generates an oscillation signal by applying a voltage to a crystal oscillator, and a frequency dividing circuit 142 that generates a reference signal having a predetermined frequency by dividing the oscillation signal. The timekeeping circuit 14 is configured by, for example, an integrated circuit (IC). The timekeeping circuit 14 keeps the internal time on the basis of the reference signal. The timekeeping circuit 14 maintains the internal time at standard time on the basis of standard radio waves, radio waves from a global positioning system (GPS) satellite, time information acquired from a network time protocol (NTP) server, or the like. Thus, the time correction device 1 may include a communication interface (I/F) 15 equivalent to an antenna configured to receive standard radio waves, broadcast radio waves, radio waves from a GPS satellite, or the like, a network I/F configured to receive signals from an NTP server, or the like. The network I/F may acquire time information from an external device by various communication standards such as a mobile communication system, including fourth and fifth generations, a public line, and short-range wireless communication. The timekeeping circuit 14 may correct the internal time in response to time information periodically acquired from the external device via the communication I/F 15.

The timekeeping circuit 14 may be an atomic clock that generates a reference signal on the basis of a frequency specific to atoms. In this case, the time correction device 1 can maintain the internal time at standard time for a long period of time, and thus need not include the communication I/F 15. Alternatively, the timekeeping circuit 14 may have any configuration provided that, when the time indicated by the watch 2 is corrected to a desired time, the timekeeping circuit 14 can keep the desired time as the internal time.

The control circuit 30 includes, for example, a processing circuit 31 constituted by a central processing unit (CPU) or the like, and a storage device 32 constituted by semiconductor memory or the like. The control circuit 30 constitutes a computer system for processing the operations required in the time correction method by the time correction device 1. The processing circuit 31 realizes the functions described in the exemplary embodiments by, for example, executing programs stored in the storage device 32. The storage device 32 is, for example, a computer readable storage medium that stores a series of processing programs and various types of data necessary for operation of the processing circuit 31. The storage device 32 is not limited to a non-volatile auxiliary storage, and may include volatile main storage devices such as a register built into the CPU. The control circuit 30 may be composed of integrated hardware or may be composed of a plurality of separate hardware. Further, the control circuit 30 may also serve as the IC constituting the timekeeping circuit 14.

The processing circuit 31 sequentially inputs the data of the image including the position of the hand 21 from the detector 12. The processing circuit 31 acquires the indicated time indicated by the hand 21 by image processing from the image input from the detector 12. The processing circuit 31 acquires the indicated time by, for example, recognizing the hand 21 and the dial 23 on the basis of features extracted from the image. The processing circuit 31 sequentially compares the internal time kept by the timekeeping circuit 14 and the indicated time indicated by the hand 21. The processing circuit 31 rotates the crown 22 via the operation mechanism 13 as long as there is a difference between the internal time and the indicated time. Note that the internal time and the indicated time need only be information that can be compared to each other. Thus, for example, the processing circuit 31 may generate as the internal time an image that includes the hand indicating the internal time, and compare the generated image and the image input from the detector 12 by pattern-matching or the like.

Furthermore, the time correction device 1 may include, for example, an input I/F 16 that provides instructions on starting the time correction method to the control circuit 30 in response to an input operation by the user, and an output I/F 17 that notifies the user of the start and the end of the time correction method by the control circuit 30. As the input I/F 16, various switches such as a push button or touch sensor, for example, can be employed. As the output I/F 17, for example, a light source that emits light, a display device that displays images and characters, and an output device such as a speaker that plays audio can be employed.

The operation mechanism 13 includes an actuator 131 driven by the control of the control circuit 30, and an operation unit 132 that operates the crown 22 in conjunction with the driving of the actuator 131. The actuator 131 is at least one of various actuators including, for example, a servo motor, a stepping motor, an ultrasonic motor, and the like. The actuator 131 may be any actuator provided that the actuator drives the operation unit 132 in accordance with the control by the control circuit 30. Further, a combination of a plurality of types of actuators may be employed as the actuator 131.

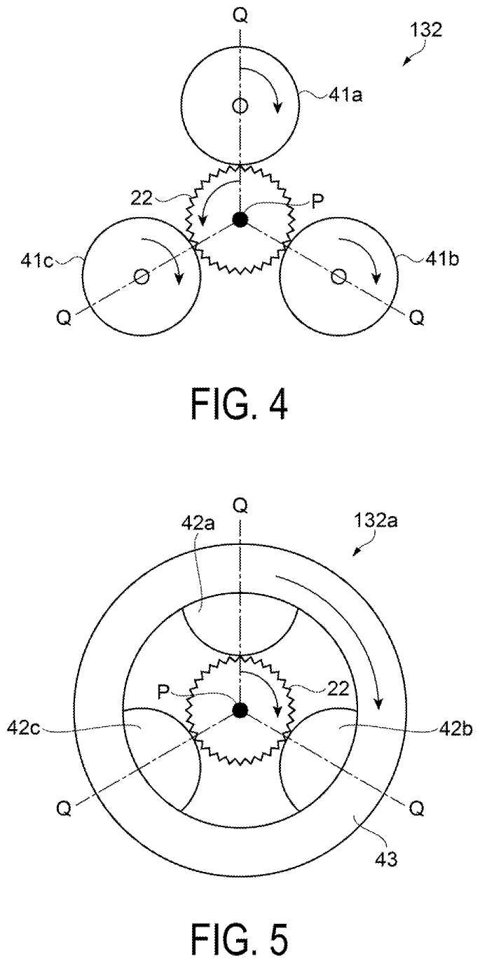

As illustrated in FIG. 4, for example, the operation unit 132 includes three contact members 41a, 41b, 41c that come into contact with the crown 22. The contact members 41a to 41c come into contact with the crown 22, pulling, pushing, and rotating the crown 22. The contact members 41a to 41c each have a circular plate or a cylindrical shape with a center along an axis P of the crown 22. The contact member 41a to 41c are disposed on the same plane orthogonal to the axis P and move in a direction Q toward the axis P to chuck a side surface of the crown 22. The contact members 41a to 41c rotate the crown 22 in the reverse direction by rotating in the same direction with the crown 22 chucked. Also, the contact members 41a to 41c are integrally driven in a direction along the axis P integrally to pull out or push in the crown 22. The operation unit 132 may pinch and chuck the watch 2 along with the regulating portion 19 with the contact members 41a to 41c chucking the crown 22.

The contact members 41a to 41c may be driven by the actuator 131 to move in the direction Q, and may be imparted with a force toward the crown 22 by a spring or the like. The contact members 41a to 41c may have a roughness on a side surface to allow for multiple types of operations performed on the crown 22, and may include an elastomer forming a side surface. This makes it possible to suppress the occurrence of slippage or scratching during operations performed on the crown 22.

Alternatively, as illustrated in FIG. 5 for example, instead of the operation unit 132 including the contact members 41a to 41c that rotate, an operation unit 132a may be employed that includes contact members 42a to 42c that revolve around the crown 22 and a carrier 43 that holds the contact members 42a to 42c. The carrier 43 guides the contact members 42a to 42c, moving the contact members 42a to 42c driven by the actuator 131 in the direction Q. The carrier 43 operates the crown 22 by integrally rotating the contact members 42a to 42c about the axis P and moving the contact members 42a to 42c along the axis P with the contact members 42a to 42c chucking the crown 22. In addition, the operation unit 132 may have gears, racks, infinity tracks, and various structures equivalent thereto that engage with grooves provided to various chucks, robotic hands, and the crown 22.

The operation mechanism 13 may be configured to detect or change the force applied when the crown 22 is operated. For example, when the operation mechanism 13 pulls out the crown 22, the control circuit 31 may control the operation mechanism 13 to increase, over time, a force that pulls out the crown 22. In this way, the time correction device 1 can suppress the occurrence of failure in the watch 2 caused by operating the crown 22 with excessive force.

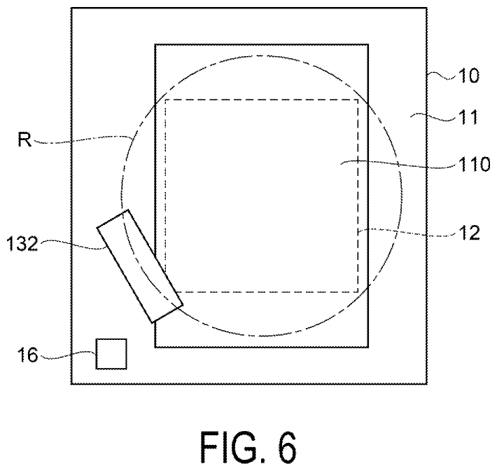

Further, as illustrated in FIG. 6, the operation unit 132 may be moved on the mounting stand 11 to accommodate the watch 2 including the crown 22 irregularly arranged. For example, the processing circuit 31 acquires the position of the crown 22 from the image including the crown 22 taken by the detector 12, and drives the operation unit 132 via the actuator 131 to accommodate to the crown 22. As illustrated in FIG. 6, the operation unit 132 may be driven on a trajectory R that forms an arc in a planar pattern viewed from above. The operation unit 132 may be driven to further rotate on the trajectory R. Further, the operation unit 132 may be driven in an up and down direction, that is, in a thickness direction of the watch 2. A sensor for retrieving the position of the crown 22 may be separate from the detector 12, and may be provided to the operation unit 132. The sensor for acquiring the position of the crown 22 is not limited to an image sensor, and may be a distance measurement sensor, a proximity sensor, or the like.

Time Modification Method

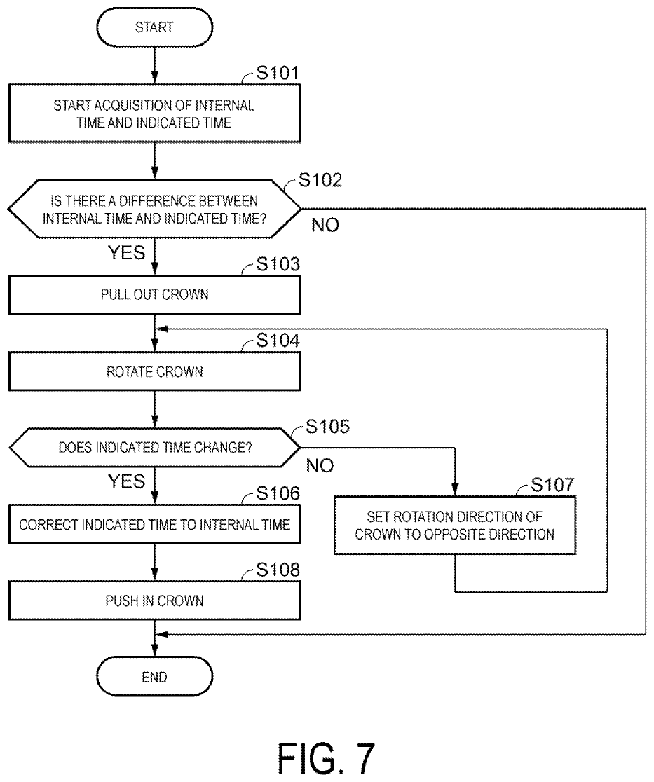

An example of a method for correcting the time of the watch 2 by the time correction device according to the first exemplary embodiment will now be described with reference to the flowchart of FIG. 7. The series of processes shown in FIG. 7 is, for example, started by inputting a signal from the input I/F 16 to the processing circuit 31 in response to an input operation by the user with the watch 2 mounted on the mounting stand 11 by the user. With the watch 2 mounted on the mounting stand 11, the case 24 may be relatively fixed to the mounting stand 11 and the crown 22 may be chucked to the operation unit 132 before the start of the time correction process.

First, in step S101, the processing circuit 31 starts to acquire the internal time from the timekeeping circuit 14. Further, the processing circuit 31 turns on the detector 12 to start detection of the position of the hand 21 of the watch 2 by the detector 12. That is, the detector 12 takes an image of the display face d of the watch 2. The processing circuit 31 sequentially inputs the data of the image including the position of the hand 21 from the detector 12. The processing circuit 31 starts to acquire the indicated time indicated by the hand 21 by image processing from the data of the image including the position of the hand 21 input from the detector 12.

In step S102, the processing circuit 31 determines whether or not there is a difference between the internal time kept by the timekeeping circuit 14 and the indicated time indicated by the hand 21. The processing circuit 31 advances the processing to step S103 when there is a difference between the internal time and the indicated time, and ends the processing when there is not a difference.

In step S103, the processing circuit 31, by controlling the operation mechanism 13, pulls out and moves the crown 22 from the position P0 at stage 0, which is the normal position, to the position P0 at stage 1, which is the time correction position, before rotating the crown 22. Note that the time correction position may be different depending on the type of watch. Further, provided that the crown 22 is pulled out in advance by the user when the watch 2 is mounted on the mounting stand 11, the step S103 of pulling out the crown 22 may be omitted.

In step S104, the processing circuit 31, by controlling the operation mechanism 13, rotates the crown 22 in a preset direction, such as clockwise, for example. In step S105, the processing circuit 31 determines whether the position, that is, the indicated time, of the hand 21 detected by the detector 12 is to be changed in conjunction with the rotation of the crown 22 in step S104. The processing circuit 31 advances the processing to step S106 when the indicated time is to be changed, and to step S107 when the indicated time is not to be changed. In step S107, the processing circuit 31 sets the rotation direction of the crown 22 to a direction opposite to the rotation direction in the previous step S104, such as counterclockwise, for example, and returns to step S104.

In step S106, the processing circuit 31 rotates the crown 22 via the operation mechanism 13 so that the indicated time indicated by the hand 21 matches the internal time kept by the timekeeping circuit 14. That is, the processing circuit 31, by controlling the operation mechanism 13 and rotating the crown 22, corrects the indicated time to the internal time.

In step S108, the processing circuit 31, by controlling the operation mechanism 13, pushes in and moves the crown 22 to the position P0 at stage 1, which is the normal position. The crown 22 is pushed inward in step S108 as soon as the indicated time matches the internal time in step S106, and therefore the processing circuit 31 can accurately synchronize the indicated time of the watch 2 with the internal time. Further, the processing circuit 31 turns off the detector 12. That is, the processing circuit 31 stops detection of the position of the hand 21 by the detector 12, and ends the series of processes. When the processes are ended, the processing circuit 31 may output a notification to the user via the output I/F 17 indicating that time correction of the watch 2 has finished.

Note that the processing in step S106 described above is performed by comparing, per predetermined sampling period, for example, the internal time and the indicated time, and rotating the crown 22 until there is no longer a difference between the two. The sampling period may be set in accordance with a driving frequency of the actuator 131 indirectly rotating the crown 22, or may be set in accordance with a frame rate of the detector 12. Further, in the processing of step S105 described above, the processing circuit 31 may be made to determine whether or not the indicated time is approaching the internal time. In a watch in which the indicated time is corrected, the time from start to finish of time correction can be shortened by rotating the crown in the time correction position in both directions.

As described above, according to the time correction device 1 according to the first exemplary embodiment, the crown 22 exposed from the case 24 is automatically operated while the position of the hand 21 of the watch 2 is detected by the detector 12, making it possible to easily and accurately correct the indicated time of the watch 2.

### First Modified Example

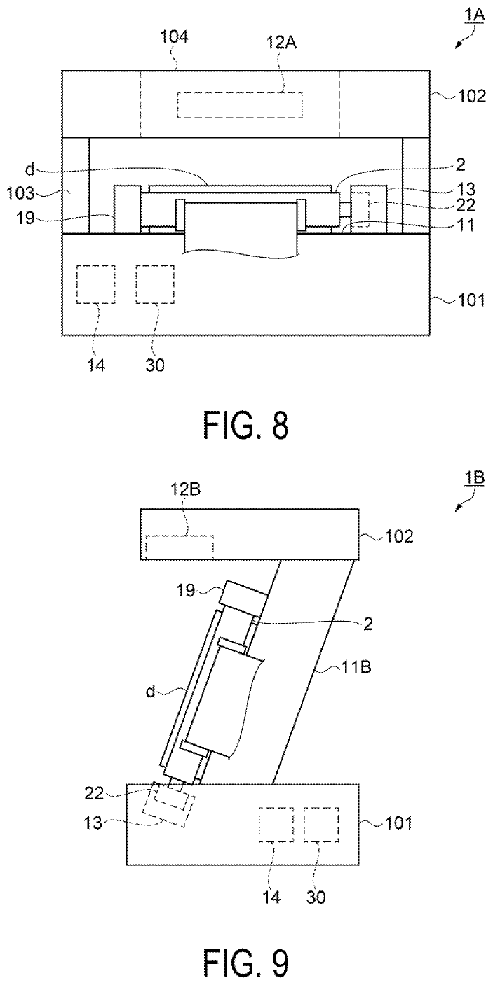

In the first exemplary embodiment described above, an example has been described in which the watch 2 is mounted on the mounting stand 11 with the display face d facing downward, but the watch 2 may be mounted on the mounting stand 11 with the display face d facing upward. That is, as illustrated in FIG. 8, a time correction device 1A according to a first modified example of the first exemplary embodiment includes a detector 12A disposed above the watch 2 to detect the position of the hand 21 of the watch 2 mounted on the mounting stand 11 with the display face d facing upward.

The time correction device 1A includes, for example, a first housing 101 that houses the timekeeping circuit 14 and the control circuit 30, a second housing 102 that houses the detector 12A, and a coupling portion 103 that couples the first housing 101 and the second housing 102. The first housing 101 is similar to the housing 10 in including the mounting stand 11. The coupling portion 103 is, for example, a link mechanism that couples the first housing 101 and the second housing 102 so that the second housing 102 is displaced relative to the first housing 101 to release the mounting stand 11 from the watch 2. The second housing 102 is disposed, for example, covering the watch 2 mounted on the mounting stand 11 from above. In this case, the second housing 102 may have a viewing window 104 that transmits light. The viewing window 104 allows the user to view the hand 21 of the watch 2 mounted on the mounting stand 11. The viewing window 104 may be a transparent material such as glass, or a through hole.

The detector 12A may be disposed in an interior of the viewing window 104 provided that the configuration is one in which light is not shielded in the viewing window 104, for example, provided that the detector 12A is small or transparent enough to allow viewing of the hand 21 by the user. A transparent imaging element may be disposed in the viewing window 104, allowing the user to view the hand 21. The viewing window 104 may guide the light of the display face d of the watch 2 to the detector 12A disposed outside the viewing window 104 by an optical system including a light guide plate, a half mirror, a hologram, or the like. The time correction device 1A, by making the user see the hand 21, can notify the user that time correction is being performed or is finished.

Further, the second housing 102 may also be adjusted in height by the coupling portion 103 to vary the distance between the second housing 102 or the detector 12A and the watch 2. With a variable distance between the watch 2 and the second housing 102, the time correction device 1A can accommodate watches of various thicknesses. Further, contact with the detector 12 reduces the likelihood that the watch 2 will be damaged.

Alternatively, the second housing 102 may function as the regulating portion 19 by coming into contact with the watch 2 and sandwiching the watch 2 along with the mounting stand 11. In this case, the location of the second housing 102 that comes into contact with the watch 2 is made from a flexible material, making it possible to suppress damage to the watch 2.

### Second Modified Example

The display face d of the watch 2 need not be disposed horizontally, and a detection direction of a detector 12B need not be in the normal direction of the display face d. For example, as illustrated in FIG. 9, a time correction device 1B according to a second modified example of the first exemplary embodiment includes a mounting stand 11B on which the watch 2 is mounted so that the display face d is inclined relative to the horizontal plane, that is, relative to a bottom surface of the time correction device 1B. The mounting stand 11B may mount the watch 2 so that the display face d is orthogonal to the horizontal plane.

The time correction device 1B includes, for example, the first housing 101 that houses the timekeeping circuit 14 and the control circuit 30, and the second housing 102 that houses the detector 12B. The mounting stand 11B couples the first housing 101 and the second housing 102. The detector 12B is disposed in the second housing 102 so as to be able to detect the display face d of the mounted watch 2. For example, when the display face d is inclined upward, the detector 12B takes a downward image of the display face d from above the watch 2. In this way, the detector 12B detects the position of the hand 21 so that the detection direction, that is, the angle formed between a direction of an optical axis of the detector 12B and the display face d is an acute angle.

The image input from the detector 12B to the processing circuit 31 is an image taken at an incline relative to the display face d, and thus has distortion in comparison with the display face d viewed from the normal direction. Thus, the processing circuit 31 may generate a corrected image in which the distortion has been eliminated by performing image processing, such as an affine transformation, on the image input from the detector 12B. The processing circuit 31 may acquire the indicated time indicated by the hand 21 from the corrected image by further image processing.

According to the time correction device 1B, because the first housing 101 positioned above the mounting stand 11B does not cover the mounting stand 11B, the user can easily mount the watch 2. Also, according to the time correction device 1B, because the display face d of the watch 2 is not optically shielded, the user can view the hand 21 of the watch 2 mounted on the mounting stand 11B.

### Second Exemplary Embodiment

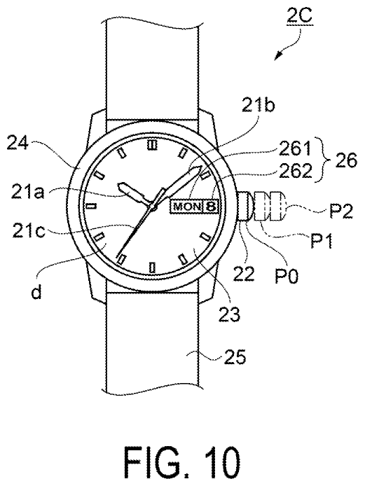

As illustrated in FIG. 10, the time correction device according to a second exemplary embodiment differs from that in the first exemplary embodiment described above in that the time correction device corrects the indicated time and an indicated calendar of a watch 2C including a calendar indicator 26. The components, actions, and effects not described in the second exemplary embodiment are the same as those of the first exemplary embodiment, and thus descriptions thereof are omitted. The time correction device according to the second exemplary embodiment may have a mechanical structure similar to that of any one of the time correction devices 1, 1A, 1B described above. In the following, the time correction device according to the second exemplary embodiment is illustratively described as a time correction device 1C having a mechanical structure similar to that of the time correction device 1 illustrated in FIG. 1 and FIG. 3.

The watch 2C has a configuration similar to that of the watch 2 described above, except for, for example, the configuration related to the calendar indicator 26. The calendar indicator 26 indicates a calendar of at least one of a date, a day, a month, a moon phase, a year, or the like. The calendar indicator 26 includes a day indicator 261 and a date indicator 262, for example. The day indicator 261 includes, for example, a day indicator and a display window indicating the day by selectively displaying a day marked on the day indicator. The date indicator 262 includes, for example, a date indicator and a display window indicating the date by selectively displaying a date marked on the date indicator. The display window of the day indicator 261 may be commonly used as the display window of the date indicator 262. The calendar indicator 26 may be configured so that a hand indicates the calendar, such as a date, a day, or the like, marked on the dial 23.

For example, as illustrated in FIG. 10, the crown 22 moves incrementally to the position P0 at stage 0, the position P1 at stage 1, and a position P2 at stage 2 of the watch 2C. In the watch 2C, the position P0 is the normal position, the position P1 is the calendar correction position, and the position P2 is the time correction position. For example, the hand 21 indicates the time kept by the watch 2C when the crown 22 is in the normal position, and interlocks with the rotation of the crown 22 when the crown 22 is in the time correction position. When the crown 22 is in the calendar correction position, the calendar indicator 26 changes the calendar, such as the date, the day, or the like indicated in conjunction with the rotation of the crown 22.

In the time correction device 1C, the timekeeping circuit 14 keeps the internal time and an internal calendar that is at least one of a date, a day, a month, a moon phase, a year, and the like. When the time correction device 1C includes the communication I/F 15, the timekeeping circuit 14 may acquire information with respect to the time and the calendar from an external device via the communication I/F 15, and periodically correct the internal time and the internal calendar, for example.

The detector 12 detects the calendar indicator 26 displayed on the display face d, for example. Specifically, the detector 12 takes an image of the display face d including the indicated calendar indicated by the calendar indicator 26, and sequentially outputs the data of the image taken to the processing circuit 31. The processing circuit 31 of the time correction device 1C recognizes the date, the day, or the like indicated by the calendar indicator 26 by image processing the input image. In this way, the processing circuit 31 recognizes, for example, a number indicating the date, or a letter or a symbol indicating the day, and thus acquires the indicated calendar indicated by the calendar indicator 26.

In the time correction device 1C, the processing circuit 31 controls the operation mechanism 13 to rotate the crown 22 in accordance with the difference between the indicated calendar and the internal calendar, and thus corrects the indicated calendar to the internal calendar. That is, the processing circuit 31 sequentially compares the internal calendar kept by the timekeeping circuit 14 and the indicated calendar indicated by the calendar indicator 26. Thus, the indicated calendar and the internal calendar need only be information that can be compared to each other.

The operation mechanism 13 performs operations such as pulling, pushing, rotating, and the like on the crown 22. The operation mechanism 13 may be configured to detect or change the force applied when the crown 22 is operated. For example, the processing circuit 31 may be configured to determine the position of the crown 22 in response to a change in the force used by the operation mechanism 13 to pull out the crown 22, the force being detected by a force sensor. Further, the operation mechanism 13 may be configured to detect an amount of displacement of the operation unit 132. In this case, the processing circuit 31 may determine the position of the crown 22 in the axial direction in accordance with the amount of displacement of the operation unit 132 extending in the axial direction of the crown 22.

Time Correction Method

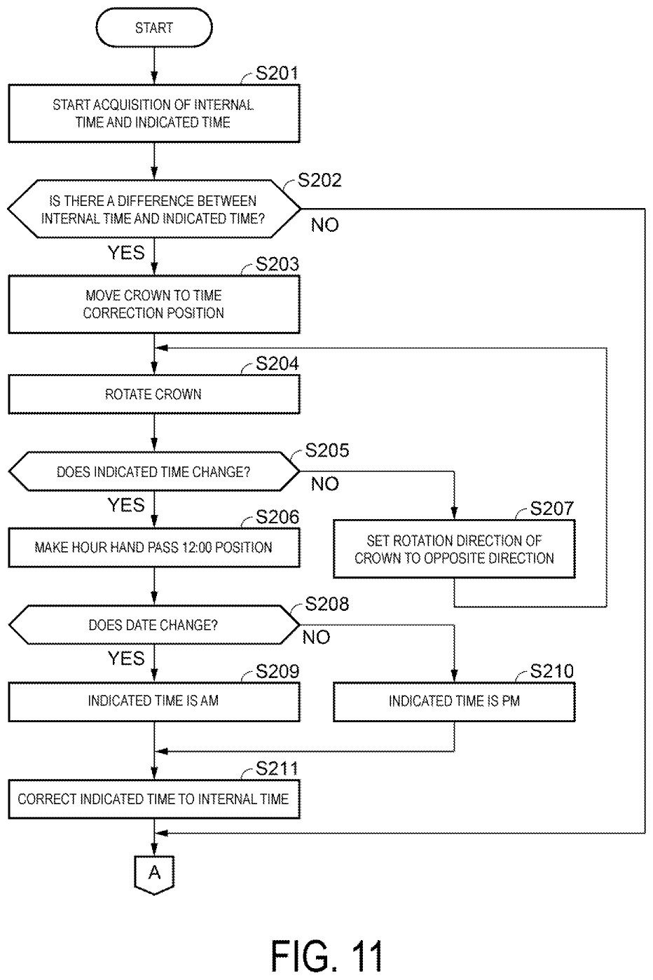

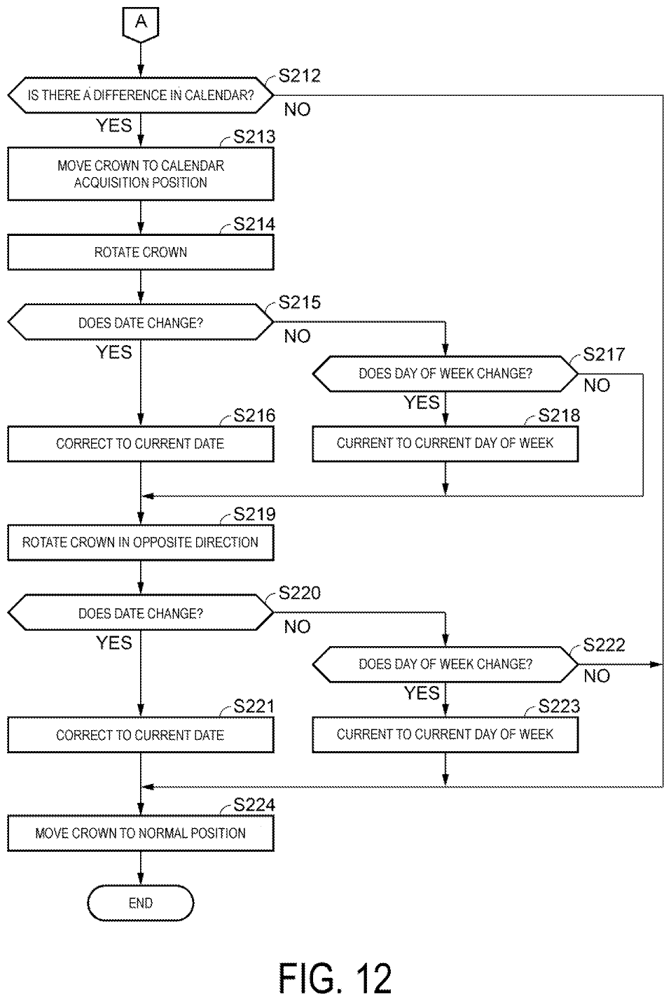

An example of a method for correcting the time of the watch 2C by the time correction device 1C according to the second exemplary embodiment will now be described with reference to the flowcharts shown in FIG. 11 and FIG. 12. Similar to the first exemplary embodiment, the series of processes shown in FIG. 11 and FIG. 12 is started by a signal being input from the input I/F 16 to the processing circuit 31 in response to an input operation of the user, for example.

First, in step S201 of FIG. 11, the processing circuit 31 starts to acquire an internal time from the timekeeping circuit 14. Further, the processing circuit 31 turns on the detector 12 to start detection of the position of the hand 21 of the watch 2C by the detector 12. The processing circuit 31 starts to acquire the indicated time indicated by the hand 21 from the position of the hand 21 detected by the detector 12.

In step S202, the processing circuit 31 determines whether or not there is a difference between the internal time kept by the timekeeping circuit 14 and the indicated time indicated by the hand 21. The processing circuit 31 advances the processing to step S203 when there is a difference between the internal time and the indicated time, and advances the processing to step S212 when there is not a difference.

In step S203, the processing circuit 31, by controlling the operation mechanism 13, pushes out and moves the crown 22 of the watch 2C to the position P2 at stage 2, which is the time correction position of the watch 2C. Similar to the first exemplary embodiment, provided that the crown 22 is pulled out in advance by the user, the step S203 of pulling out the crown 22 may be omitted.

In step S204, the processing circuit 31, by controlling the operation mechanism 13, rotates the crown 22 in a preset direction, such as clockwise, for example. In step S205, the processing circuit 31 determines whether the position, that is, the indicated time, of the hand 21 detected by the detector 12 is to be changed in a forward direction. The processing circuit 31 advances the processing to step S206 when the indicated time is to be changed, and to step S207 when the indicated time is not to be changed. In step S207, the processing circuit 31 sets the rotation direction of the crown 22 to a direction opposite to the rotation direction in the previous step S204, such as counterclockwise, for example, and returns to step S204.

In step S206, the processing circuit 31 rotates the crown 22 via the operation mechanism 13 so that the hour hand 21a passes over the 12:00 position. The processing circuit 31 advances the process to step S208 as soon as the position of the hour hand 21a detected by the detector 12 has passed over the 12:00 position.

In step S208, the processing circuit 31 determines whether the date indicated by the date indicator 262 changed in response to the hour hand 21a passing over the 12:00 position in step S206. That is, the processing circuit 31 recognizes the indicated date by performing image processing on an image including the date indicator 262 and detected by the detector 12, and determines whether or not the recognized date changed. When the date changed, in step S209, the processing circuit 31 determines that the indicated time is AM. When the date does not change, in step S210, the processing circuit 31 determines that the indicated time is PM.

In step S211, the processing circuit 31 controls the operation mechanism 13 to rotate the crown 22 and thus correct the indicated time confirmed in step S209 or step S210 to the internal time. That is, the processing circuit 31 rotates the crown 22 via the operation mechanism 13 so that the indicated time matches the internal time kept by the timekeeping circuit 14, taking into consideration AM and PM.

Next, in step S212 of FIG. 12, the processing circuit 31 determines whether or not there is a difference between the internal calendar kept by the timekeeping circuit 14 and the indicated calendar acquired by the detector 12. That is, when the date and the day are indicated as the indicated calendar by the calendar indicator 26, the processing circuit 31 sequentially compares the date and the day of the internal calendar and the indicated calendar acquired by the detector 12. The processing circuit 31 advances the processing to step S213 when there is a difference between the internal calendar and the indicated calendar, and advances the processing to step S224 when there is not a difference.

In step S213, the processing circuit 31, by controlling the operation mechanism 13, moves the crown 22 of the watch 2C to the position P1 at stage 1, which is the calendar correction position. That is, the processing circuit 31 pushes the crown 22 in by one stage when the crown 22 is in the position P2 at stage 2, which is the time correction position, and pulls the crown 22 out by one stage when the crown 22 is in the position P0 at stage 0, which is the normal position.

In step S214, the processing circuit 31, by controlling the operation mechanism 13, rotates the crown 22 in a preset direction such as clockwise, for example. In step S215, the processing circuit 31 determines whether or not the date of the indicated calendar is to be changed in conjunction with the rotation of the crown 22 in step S214. The processing circuit 31 advances the processing to step S216 when the date is to be changed, and to step S217 when the date is not to be changed.

In step S216, the processing circuit 31 rotates the crown 22 in the rotation direction in step S214 via the operation mechanism 13 so that the date of the indicated calendar acquired by the detector 12 matches the date of the internal calendar kept by the timekeeping circuit 14. That is, the processing circuit 31 controls the operation mechanism 13 to rotate the crown 22 and thus correct the date indicated by the date indicator 262 to the date of the internal calendar.

In step S217, the processing circuit 31 determines whether or not the day of the indicated calendar is to be changed in conjunction with the rotation of the crown in step S214. The processing circuit 31 advances the processing to step S218 when the day is to be changed, and to step S219 when the day is not to be changed.

In step S218, the processing circuit 31 rotates the crown 22 in the rotation direction in step S214 via the operation mechanism 13 so that the day of the indicated calendar acquired by the detector 12 matches the day of the internal calendar kept by the timekeeping circuit 14. That is, the processing circuit 31 controls the operation mechanism 13 to rotate the crown 22, and thus corrects the day indicated by the day indicator 261 to the day of the internal calendar.

In step S219, the processing circuit 31 rotates the crown 22 in the direction opposite to the rotation direction in step S214, such as counterclockwise, for example. In step S220, the processing circuit 31 determines whether or not the date of the indicated calendar is to be changed in conjunction with the rotation of the crown 22 in step S219. The processing circuit 31 advances the processing to step S221 when the date is to be changed, and to step S222 when the date is not to be changed.

In step S221, the processing circuit 31 rotates the crown 22 in the rotation direction in step S219 via the operation mechanism 13 so that the date of the indicated calendar acquired by the detector 12 matches the date of the internal calendar kept by the timekeeping circuit 14. The processing circuit 31 controls the operation mechanism 13 to rotate the crown 22 and thus correct the date indicated by the date indicator 262 to the date of the internal calendar.

In step S222, the processing circuit 31 determines whether the day of the indicated calendar is to be changed in conjunction with the rotation of the crown in step S219. The processing circuit 31 advances the processing to step S223 when the day is to be changed, and to step S224 when the day is not to be changed.

In step S223, the processing circuit 31 rotates the crown 22 in the rotation direction in step S219 via the operation mechanism 13 so that the day of the indicated calendar acquired by the detector 12 matches the day of the internal calendar kept by the timekeeping circuit 14. The processing circuit 31 controls the operation mechanism 13 to rotate the crown 22 and thus correct the day indicated by the day indicator 261 to the day of the internal calendar.

In step S224, the processing circuit 31, by controlling the operation mechanism 13, moves the crown 22 of the watch 2C to the position P0 at stage 0, which is the normal position, and ends the processing. That is, immediately before the processing of step S224, the processing circuit 31 pushes the crown 22 in by one stage when the crown 22 is in the position P1 at stage 1, which is the calendar correction position, and pushes the crown 22 in by two stages when the crown 22 is in the position P2 at stage 2, which is the time correction position. Alternatively, when the crown 22 is already in the position P0 at stage 0, which is the normal position, the processing circuit 31 maintains the crown 22 in the position P0.

As described above, the processing circuit 31 of the time correction device 1C determines that the processing is to advance to step S213 or step S224 in step S212 as soon as the indicated time matches the internal time in step S211. The crown 22 is moved to the calendar correction position in step S213 and to the normal position in step S224. Even when the crown 22 is moved to either the calendar correction position or the normal position, the hand 21 that was stopped while the crown 22 was in the time correction position starts driving. In this way, the indicated time of the watch 2C is corrected so that the time is accurately synchronized with the internal time of the time correction device 1C.

### Third Exemplary Embodiment

The time correction device according to a third exemplary embodiment differs from the first and second exemplary embodiments described above in that the time of the watch is corrected according to different operation patterns for each caliber. The components, actions, and effects not described in the third exemplary embodiment are the same as those of the first and second exemplary embodiments, and thus descriptions thereof are omitted. The time correction device according to the third exemplary embodiment may have a mechanical structure similar to that of any one of the time correction devices 1, 1A, 1B described above. In the following, the time correction device according to the third exemplary embodiment is illustratively described as a time correction device 1D having a mechanical structure similar to the time correction device 1 illustrated in FIG. 1 and FIG. 3.

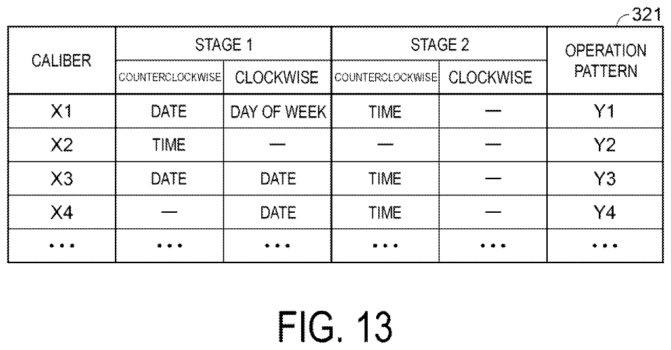

As illustrated in FIG. 13, the storage device 32 of the time correction device 1D stores caliber information 321, which is electronic data with recorded operation patterns specific to each caliber. Here, “caliber” refers to a format for expressing an identity of a movement of a watch. The movement refers to a module of components housed in the case 24. The recorded caliber information 321 associates operation patterns and correction items corresponding to the position and the rotational direction of the crown, respectively, for each of the plurality of calibers. The operation pattern may be a pattern of processing by a series of processing circuits 31 for correcting the time of the watch in the time correction device 1D.

For example, the processing circuit 31 of the time correction device 1D causes the output I/F 17, which is a display device such as a liquid crystal display, to display a list of calibers recorded in the caliber information 321 in response to a signal instructing activation and input from the input I/F 16 by an input operation by the user on the input I/F 16. In response to an input operation by the user selecting a caliber of a watch mounted on the mounting stand 11, the input I/F 16 outputs, from the list of calibers, a signal identifying one caliber from the plurality of calibers recorded in the caliber information 321 to the processing circuit 31. The processing circuit 31 controls the operation mechanism 30 to operate the crown 22 according to the operation pattern corresponding to the identified caliber.

For example, assume that the caliber of the watch 2 not having a function for displaying a calendar, such as a date and day, is called X2, as shown in FIG. 13. The processing circuit 31 reads the caliber information 321 from the storage device 32, and presents each name of the caliber recorded in the caliber information 321 to the user via the output I/F 17, which is a display device. The input I/F 16 outputs, to the processing circuit 31, a signal identifying the caliber of X2 in response to an input operation by a user. The processing circuit 31 refers to the caliber information 321 and identifies an operation pattern of Y2 associated with the caliber X2 thus identified. The processing circuit 31 controls the operation mechanism 30 to operate the crown 22 according to the operation pattern of Y2 thus identified.

For example, the operation pattern of Y2 may be a series of processing patterns that do not include processing for correcting a calendar, such as date and a day, as in the flowchart of FIG. 7. According to the caliber X2, the indicated time is corrected only when the crown 22 rotates counterclockwise at the position P1 of stage 1. Thus, the preset direction, which is the rotation direction in the initial step S104, may be counterclockwise. Additionally, in step S105, when the processing circuit 31 determines that the indicated time does not change, the processing circuit 31 may notify the user of the error via the output I/F 17 without changing the rotational direction of the crown to the opposite direction.

Alternatively, when the name of the caliber of the watch 2C having the function of displaying a calendar of a date and a day is X1 shown in FIG. 13, the operation pattern of Y1 may be a series of processes shown in the flowcharts of FIG. 11 and FIG. 12. The configuration of the rotation direction, detected object, and the like of the operation pattern may be changed as appropriate in accordance with the corrected item of the crown 22 recorded in the caliber information 321.

Note that in the caliber information 321 shown in FIG. 13, for the caliber X3, the date is changed when the crown positioned in the position P1 at stage 1 is rotated in either the clockwise direction or the counterclockwise direction. When the caliber of the watch subject to time correction is X3, the processing circuit 31 may rotate the crown, for example, to determine whether or not the difference between the date of the indicated calendar and the date of the internal calendar increases. The processing circuit 31 may set the rotation direction to the opposite direction when the difference increases, and may maintain the rotation direction when the difference decreases.

As described above, the processing circuit 31 controls the operation mechanism 30 to operate the crown 22 according to a pattern specific to the caliber of the watch mounted on the mounting stand 11. Thus, according to the time correction device 1D, the time from start to finish of time correction can be shortened by omitting the movement of the crown 22 to an unnecessary position and the rotation of the crown 22 in an unnecessary direction.

### Other Exemplary Embodiments

While the first to third exemplary embodiments were thus described above, the present disclosure is not limited to these disclosures. The configuration of each component may be substituted for any configuration having similar functionality, and any component in the exemplary embodiments may be omitted or added within the technical scope of the present disclosure. Thus, from these disclosures, various alternative exemplary embodiments will become apparent to those skilled in the art.

For example, in the first exemplary embodiment, the operation mechanism 13 need not be configured to pull out and push in the crown 22. In this case, the watch 2 is mounted on the mounting stand 11 with the crown 22 pulled out by the user. Then, even after correction of the indicated time is finished, the processing circuit 31 continues rotating the crown 22 with the indicated time matching the internal time. The user may push in the crown 22 at the normal position once the watch 2 is removed from the mounting stand 11. Thus, while a slight difference from the internal time may occur in the indicated time, the manufacturing cost of the time correction device can be reduced.

Further, in the first to third exemplary embodiments, the processing circuit 31 may pull out the crown 22 via the operation mechanism 13 when the indicated time is 0 seconds, and push in the crown 22 when the internal time is 0 seconds.

Further, while the time correction method is triggered by operation of the input I/F 16 by the user in the first and second exemplary embodiments, the time correction method may be automatically performed in response to the watch 2 being mounted in a predetermined position on the mounting stand 11. In this case, the time correction device may include a sensor, such as a proximity sensor, that detects that a watch has been mounted on the mounting stand 11, as the input I/F 16.

Further, in the first and second exemplary embodiments, the processing circuit 31 may notify the user of an error via the output I/F 17 when the indicated time does not change in conjunction with rotation of the crown 22 as in the third exemplary embodiment. Further, in the first and second exemplary embodiments, the processing circuit 31 may notify the user of an error via the output I/F 17 when the indicated calendar does not change in conjunction with rotation of the crown 22, when the crown 22 does not move in the axial direction by the operation mechanism 13, or the like. This may allow the user to notice a fault or a locking mechanism of the crown.

Further, in the third exemplary embodiment, identification of the caliber may be performed without an input operation by the user. For example, the storage device 32 stores a database in which the caliber associated with each of the images of the plurality of types of display faces d is recorded. The processing circuit 31 may refer to the database to identify the caliber corresponding to an image of the display face d taken by the detector 12. Further, the caliber may be identified using an external device such as a smartphone. For example, the user selects one caliber from the list of calibers displayed on the smartphone. The processing circuit 31 may identify the caliber by obtaining, via the communication I/F 15, the selected caliber information from the smartphone.

Additionally, in the first to third exemplary embodiments, the time correction device may have a function for winding a mainspring of a mechanical watch. For example, the input I/F 16 outputs, to the processing circuit 31, a signal instructing winding of the mainspring in response to an input operation by the user. In response, the processing circuit 31 controls the operation mechanism 13 to rotate the crown 22 positioned in the normal position. This causes the mainspring to be wound, depending on the type of watch. Alternatively, the time correction device may have a winder mechanism for driving the mounting stand 11 in order to move an automatic watch or a watch with an automatic power generating system.

Further, in the first to third exemplary embodiments, when the time correction device includes a display device as the output I/F 17, the processing circuit 31 may display, on the display device, information such as the date and time, weather, and the like acquired by the communication I/F 15, in addition to the internal time kept by the timekeeping circuit 14. This makes it possible to use the time correction device as an information presentation device even when time correction of the watch is not performed.

Furthermore, it is a matter of course that the present disclosure includes various exemplary embodiments, which have not been described herein, such as configurations and the like resulting from application of the described exemplary embodiments to one another. Accordingly, the technical scope of the present disclosure shall be determined only on the basis of matters defining the disclosure relating to the scope of claims, which is judged as appropriate from the foregoing descriptions.

The contents derived from the exemplary embodiments described above will be described below.

A time correction device includes a mounting stand on which a watch is mounted, a detector configured to detect a position of a hand of the watch mounted on the mounting stand, an operation mechanism configured to operate a crown of the watch mounted on the mounting stand, a timekeeping circuit configured to keep an internal time, and a control circuit configured to acquire an indicated time indicated by the hand from the position of the hand and control the operation mechanism to rotate the crown in accordance with a difference between the internal time and the indicated time and thus correct the indicated time to the internal time.

According to this configuration, the operation mechanism operates the crown while the position of the hand of the watch is detected by the detector, making it possible to easily correct the indicated time of the watch.

In the time correction device described above, the control circuit may be configured to control the operation mechanism prior to rotating the crown to pull out the crown at a time correction position for interlocking the hand with rotation of the crown.

According to this configuration, it is not necessary for the user to pull out the crown, for example, and thus the indicated time of the watch can be more easily corrected.

In the time correction device described above, the control circuit may be configured to control the operation mechanism to increase, over time, a force for pulling out the crown.

According to this configuration, it is possible to suppress watch failure caused by, for example, sudden generation of an excessive force for pulling out the crown.

In the time correction device described above, the control circuit may be configured to control the operation mechanism to push in the crown at a normal position for driving the hand synchronously with time when the indicated time matches the internal time.

According to this configuration, the driving of the hand is started with the indicated time matching the internal time, making it possible to finish time correction with the indicated time accurately synchronized with the internal time.

In the time correction device described above, the control circuit may be configured to control the operation mechanism to operate the crown based on a pattern specific to a caliber of the watch.

According to this configuration, operation patterns that differ for each caliber are used to operate the crown, making it possible to omit unnecessary operations and shorten the time from start to finish of time correction.

In the time correction device described above, the detector may be configured to take an image including a scale of a dial of the watch indicated by the hand to detect a position of the hand.

According to this configuration, the position of the hand is detected from an image of the watch taken by the detector, making it possible to correct the indicated time while acquiring the indicated time of the watch.

In the time correction device described above, the detector may be a two-dimensional image sensor that uses a solid state imaging element.

According to this configuration, the position of the hand is detected from an image of the watch taken by a two-dimensional image sensor, making it possible to correct the indicated time while acquiring the indicated time of the watch.

A time correction method includes detecting a position of a hand of a watch mounted on a mounting stand by a detector, keeping an internal time by a timekeeping circuit, acquiring an indicated time indicated by the hand from a position of the hand by a control circuit, and controlling, by the control circuit, an operation mechanism configured to operate a crown of the watch mounted on the mounting stand to rotate the crown in accordance with a difference between the internal time and the indicated time and thus correct the indicated time to the internal time.

According to this configuration, the crown is automatically operated while the position of the hand of the watch is detected by the detector, making it possible to easily correct the indicated time of the watch.

What is claimed is:

1. Time correction device comprising:
a mounting stand on which a watch is mounted;
a detector configured to detect a position of a hand of the watch mounted on the mounting stand;
an operation mechanism configured to operate a crown of the watch mounted on the mounting stand;
a timekeeping circuit configured to keep an internal time; and
a control circuit configured to acquire an indicated time indicated by the hand from the position of the hand and control the operation mechanism to rotate the crown in accordance with a difference between the internal time and the indicated time and thus correct the indicated time to the internal time.

2. The time correction device according to claim 1, wherein
the control circuit is configured to control the operation mechanism prior to rotating the crown to pull out the crown at a time correction position for interlocking the hand with rotation of the crown.

3. The time correction device according to claim 2, wherein
the control circuit is configured to increase, over time, a force for pulling out the crown.

4. The time correction device according to claim 1, wherein
the control circuit is configured to control the operation mechanism to push in the crown at a normal position for driving the hand synchronously with time when the indicated time matches the internal time.

5. The time correction device according to claim 1, wherein
the control circuit is configured to control the operation mechanism to operate the crown based on a pattern specific to a caliber of the watch.

6. The time correction device according to claim 1, wherein
the detector is configured to take an image including a scale of a dial of the watch indicated by the hand to detect the position of the hand.

7. The time correction device according to claim 1, wherein
the detector is a two-dimensional image sensor that uses a solid state imaging element.

8. A time correction method comprising:
detecting, by a detector, a position of a hand of a watch mounted on a mounting stand;
keeping an internal time by a timekeeping circuit;
acquiring, by a control circuit, an indicated time indicated by the hand from the position of the hand; and
controlling, by the control circuit, an operation mechanism configured to operate a crown of the watch mounted on the mounting stand to rotate the crown in accordance with a difference between the internal time and the indicated time and thus correct the indicated time to the internal time.
